(19) United States
(12) Patent Application Publication
(10) Pub. No.: US 2015/0177646 A1
(43) Pub. Date: Jun. 25, 2015

(54) DEVICE FOR CARRIER DETERIORATION ESTIMATION, IMAGE FORMING APPARATUS INCORPORATING SAME, AND IMAGE FORMING APPARATUS MANAGEMENT SYSTEM

(71) Applicants: Masaaki YAMADA, Tokyo (JP); Akira AZAMI, Kanagawa (JP); Atsushi TANO, Kanagawa (JP); Mutsuki MORINAGA, Kanagawa (JP); Emiko SHIRAISHI, Tokyo (JP); Hiroaki KUWABARA, Kanagawa (JP)

(72) Inventors: Masaaki YAMADA, Tokyo (JP); Akira AZAMI, Kanagawa (JP); Atsushi TANO, Kanagawa (JP); Mutsuki MORINAGA, Kanagawa (JP); Emiko SHIRAISHI, Tokyo (JP); Hiroaki KUWABARA, Kanagawa (JP)

(21) Appl. No.: 14/568,318

(22) Filed: Dec. 12, 2014

(30) Foreign Application Priority Data
Dec. 19, 2013 (JP) 2013-262206

(51) Int. Cl. G03G 15/08

(52) U.S. Cl. CPC G03G 15/0824

(57) ABSTRACT

A device that estimates carrier deterioration indicating a degree of deterioration of carrier inside a developing device using a two-component developer includes a first carrier deterioration calculation unit, a second carrier deterioration calculation unit, and a carrier deterioration degree output unit. The first carrier deterioration calculation unit uses toner consumption and agitation time to calculate a first carrier deterioration degree indicating a degree of carrier deterioration caused by a spent phenomenon. The second carrier deterioration calculation unit uses the toner consumption and the agitation time to calculate a second carrier deterioration degree indicating a degree of carrier deterioration caused by a carrier abrasion phenomenon. The carrier deterioration degree output unit uses the toner consumption to select one of the first carrier deterioration degree and the second carrier deterioration degree, and outputs the selected carrier deterioration degree.

### CROSS-REFERENCE TO RELATED APPLICATION

This patent application is based on and claims priority pursuant to 35 U.S.C. §119 to Japanese Patent Application No. 2013-262206, filed on Dec. 19, 2013, in the Japan Patent Office, the entire disclosure of which is hereby incorporated by reference herein.

### BACKGROUND

1. Technical Field

Exemplary aspects of the present invention relate to a device that estimates carrier deterioration indicating a degree of deterioration of carrier in developer stored in a developing device. Exemplary aspects of the present invention also relate to an image forming apparatus including the device for carrier deterioration estimation and to an image forming apparatus management system.

2. Related Art

In image forming apparatuses using a developer (a two-component developer) containing toner and carrier, the developer inside a developing unit needs to be replaced before the developer wears out. The lifetime of the developer mainly depends on the carrier particles, which deteriorate over time. However, direct observation of carrier deterioration is difficult. Consequently, related-art image forming apparatuses, for example, often use cumulative running time of a developing device (i.e., agitation time of developer) or of a developer bearer, or the number of printouts, as an indirect indicator of the degree of deterioration; when these times or numbers reach a prescribed value, the developer is replaced.

However, since carrier deterioration varies markedly depending on the conditions under which it is used, the degree of carrier deterioration cannot be accurately estimated based on only the cumulative operating time of the developing device or developer bearer.

### SUMMARY

In at least one embodiment of this disclosure, there is provided a device that estimates carrier deterioration indicating a degree of deterioration of carrier inside a developing device using a two-component developer containing carrier and toner and including an additive.

The device for carrier deterioration estimation includes a first carrier deterioration calculation unit, a second carrier deterioration calculation unit, and a carrier deterioration degree output unit. The first carrier deterioration calculation unit uses toner consumption and agitation time to calculate a first carrier deterioration degree indicating a degree of carrier deterioration caused by a spent phenomenon, in which toner or an additive of toner adheres to a carrier surface. The toner consumption indicates an amount of toner consumed by the developing device, whereas the agitation time indicates a time period for which the two-component developer in the developing device is agitated. The second carrier deterioration calculation unit uses the toner consumption and the agitation time to calculate a second carrier deterioration degree indicating a degree of carrier deterioration caused by a carrier abrasion phenomenon, in which a carrier surface is abraded by agitation inside the developing device. The carrier deterioration degree output unit uses the toner consumption to select one of the first carrier deterioration degree and the second carrier deterioration degree, and outputs the selected carrier deterioration degree.

In at least one embodiment of this disclosure, there is provided an image forming apparatus including a latent image bearer, a developing device, and a device for carrier deterioration estimation. The developing device develops a latent image on the latent image bearer with a two-component developer containing carrier and toner including an additive. The device for carrier deterioration estimation estimates a degree of deterioration of carrier inside the developing device, and includes a first carrier deterioration calculation unit, a second carrier deterioration calculation unit, and a carrier deterioration degree output unit. The first carrier deterioration calculation unit uses toner consumption and agitation time to calculate a first carrier deterioration degree indicating a degree of carrier deterioration caused by a spent phenomenon, in which toner or an additive of toner adheres to a carrier surface. The toner consumption indicates an amount of toner consumed by the developing device, whereas the agitation time indicates a time period for which the two-component developer in the developing device is agitated. The second carrier deterioration calculation unit uses the toner consumption and the agitation time to calculate a second carrier deterioration degree indicating a degree of carrier deterioration caused by a carrier abrasion phenomenon, in which a carrier surface is abraded by agitation inside the developing device. The carrier deterioration degree output unit uses the toner consumption to select one of the first carrier deterioration degree and the second carrier deterioration degree, and outputs the selected carrier deterioration degree.

In at least one embodiment of this disclosure, there is also provided an image forming apparatus management system including an image forming apparatus and a management device connected to the image forming apparatus via a communication network. The image forming apparatus includes a latent image bearer, a developing device, a device for carrier deterioration estimation, and a carrier deterioration degree transmission unit. The developing device develops a latent image on the latent image bearer with a two-component developer containing carrier and toner including an additive. The device for carrier deterioration estimation estimates a degree of deterioration of carrier inside the developing device, and includes a first carrier deterioration calculation unit, a second carrier deterioration calculation unit, and a carrier deterioration degree output unit. The first carrier deterioration calculation unit uses toner consumption and agitation time to calculate a first carrier deterioration degree indicating a degree of carrier deterioration caused by a spent phenomenon, in which toner or an additive of toner adheres to a carrier surface. The toner consumption indicates an amount of toner consumed by the developing device, whereas the agitation time indicates a time period for which the two-component developer in the developing device is agitated. The second carrier deterioration calculation unit uses the toner consumption and the agitation time to calculate a second carrier deterioration degree indicating a degree of carrier deterioration caused by a carrier abrasion phenomenon, in which a carrier surface is abraded by agitation inside the developing device. The carrier deterioration degree output unit uses the toner consumption to select one of the first carrier deterioration degree and the second carrier deterioration degree, and outputs the selected carrier deterioration degree. The management device includes a reporting unit to report that the carrier deterioration degree is transmitted from the carrier deterioration degree transmission unit of the image forming apparatus.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1 is a diagram of an image forming apparatus according to an exemplary embodiment of the present invention;

FIG. 2 is a block diagram of a controller, serving as a device for carrier deterioration estimation, that estimates the number of output sheets to be generated by the time the developer wears out (lifetime-sheet-quantity estimation control) according to an exemplary embodiment of the present invention;

FIG. 3 is a flowchart of the lifetime-sheet-quantity estimation control according to the exemplary embodiment of the present invention;

FIG. 4 is a graph of a relationship between the number of output sheets and a spent amount when an image area ratio is changed;

FIG. 5 is a graph of a relationship between the number of output sheets and a spent amount when images are formed on prescribed-size sheets at respective four image area ratios (5%, 8.75%, 20%, and 40%);

FIG. 6 is a graph of a relationship between a spent amount calculated by a spent amount calculation unit and a measured value according to an exemplary embodiment of the present invention;

FIG. 7 is a table illustrating changes in an image area ratio when the graph illustrated in FIG. 6 is obtained;

FIG. 8 is a graph of a relationship between a development cumulative operating time and a film abrasion amount; and

FIG. 9 is a schematic diagram of a maintenance management system serving as an image forming apparatus management system according to an exemplary embodiment of the present invention.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that have the same function, operate in a similar manner, and achieve similar results.

Although the exemplary embodiments are described with technical limitations with reference to the attached drawings, such description is not intended to limit the scope of the invention and all of the components or elements described in the exemplary embodiments of this disclosure are not necessarily indispensable to the present invention.

Referring now to the drawings, exemplary embodiments of the present disclosure are described below. In the drawings for explaining the following exemplary embodiments, the same reference codes are allocated to elements (members or components) having the same function or shape and redundant descriptions thereof are omitted below.

In an image forming apparatus, carrier deteriorates over time due to two main factors: a spent phenomenon (also called spent carrier) and a carrier abrasion phenomenon (also called carrier abrasion). When toner or an external additive of the toner adheres to the surface of the carrier, chargeability of toner by the carrier deteriorates. Such a phenomenon indicates a state in which the carrier is spent, and it is called the spent phenomenon. On the other hand, when the electric resistance value of carrier is lowered due to abrasion of the carrier surface, chargeability of toner by the carrier also deteriorates. This phenomenon is called the carrier abrasion. Both phenomena are described in detail below.

The spent phenomenon is further described. In a two-component developer containing toner and carrier, an external additive is often added to the toner to enhance fluidity of the toner and a charge amount of the toner is controlled. Such an external additive is made of, for example, wax, silica, titanium oxide, aluminum oxide, zinc oxide, and magnesium oxide. In particular, the external additive with silica or titanium oxide causes the spent phenomenon to occur more easily. When images having a large image area ratio are sequentially output, the spent phenomenon is likely to occur. The image area ratio is the ratio of an imaged area to which toner adheres to the entire sheet area. That is, when the images having a large image area ratio are sequentially output, a large amount of toner is consumed in a short time. Meanwhile, a large amount of new toner is supplied to the developer, so that fine toner powder and toner additive are successively supplied to the developer. This causes the developer to contain a lot of additives released from the toner. Since the additive tends to adhere to a surface of the carrier, the spent phenomenon is likely to occur.

Next, the carrier abrasion phenomenon is further described. When the image forming apparatus consumes a small amount of toner inside a developing device, for example, when images having a small image area ratio are sequentially output, the carrier abrasion is likely to occur. That is, although a small amount of the toner inside the developing device is consumed, the developing device needs to be operated to agitate developer thereinside. Such agitation of the developer can increase the possibility of friction occurring among carrier particles and between carrier and deteriorated toner, causing the coating of the carrier to be abraded or peeled away more easily. Consequently, the carrier abrasion phenomenon is more likely to occur.

In a case where the toner or the toner additive adheres to the carrier surface due to the spent phenomenon, or the coating layer of the carrier is abraded or peeled due to the carrier abrasion phenomenon, the carrier and the toner are not appropriately charged by friction. This causes the chargeability of the toner by the carrier to deteriorate, and thus, the toner is not sufficiently charged. Consequently, an image may not be formed at a desired image density, or fogging may occur due to adhesion of the toner to a blank area. When any of such cases occurs, the developer is worn out and needs to be replaced.

Hence, according to exemplary embodiments of the present invention, there is provided a device for carrier deterioration estimation is capable of monitoring the degree of carrier deterioration with good accuracy. The use of the device enables the degree of carrier deterioration to be ascertained with good accuracy.

Hereinafter, an image forming apparatus 1 according to an exemplary embodiment of the present invention is described with reference to drawings.

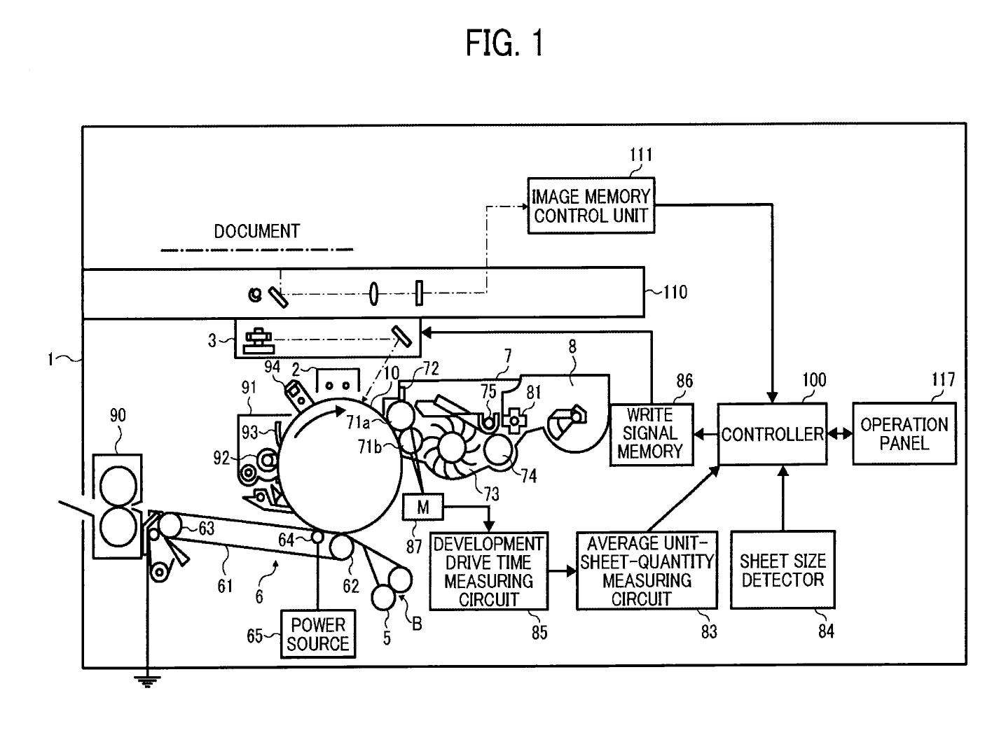

FIG. 1 is a schematic diagram of the image forming apparatus 1. The image forming apparatus 1 includes a photoconductor 10 serving as a latent image bearer, a charging device 2 serving as a charging unit, an exposure device 3 serving as a latent image forming unit, a developing device 7 serving a developing unit, a toner supply unit 8 serving as toner replenishing unit, a transfer device 6, and a registration roller 5. The charging device 2 uniformly charges a surface of the photoconductor 10. The exposure device 3 irradiates the charged surface of the photoconductor 10 with a laser beam to form a latent image. The developing device 7 supplies toner to the latent image on the surface of the photoconductor 10, thereby developing the latent image into a toner image. The toner supply unit 8 supplies toner to the developing device 7. The transfer device 6 transfers the toner image formed on the photoconductor 10 to a sheet as a recording medium. The registration roller 5 temporarily stops the sheet to be supplied to an area between the photoconductor 10 and the transfer device 6.

When such an image forming apparatus 1 forms a copy image of a document, a document reader 110 first reads an image of the document and stores the read image information in an image memory of an image memory control unit 111. Subsequently, a controller 100 of the image forming apparatus 1 reads the image information stored in the image memory to generate a write signal for control of the exposure device 3 based on the image information. The controller 100 stores the write signal in a write signal memory 86.

Meanwhile, the charging device 2 uniformly charges the surface of the photoconductor 10 to a voltage of approximately −900 V. The exposure device 3 irradiates the negatively charged surface of the photoconductor 10 with the laser beam according to the write signal in the write signal memory 86. This decreases a voltage of the irradiated area on the surface of the photoconductor 10 to approximately −50 V, thereby forming an electrostatic latent image on the surface of the photoconductor 10. The developing device 7 supplies negatively charged non-magnetic toner to the electrostatic latent image, so that a toner image is formed on the surface of the photoconductor 10.

The developing device 7, serving as a two-component developing device, stores a two-component developer containing carrier made of a magnetic material and non-magnetic toner. The magnetic carrier and the non-magnetic toner are mixed at a predetermined ratio (toner density), and stored in the developing device 7. The developing device 7 includes first and second developing rollers 71a and 71b, a developing doctor 72, and agitation members 73, 74, and 75. The first and second developing rollers 71a and 71b supply the toner in the developer to the photoconductor 10. The developing doctor 72 regulates an amount of the developer carried on the first developer roller 71a. The agitation members 73, 74, and 75 agitate the developer stored in the developing device 7. A developing motor 87 drives driving members such as the first and second developing rollers 71a and 71b and the agitation members 73, 74, and 75.

The toner supply unit 8, disposed adjacent to the developing device 7, supplies the toner conveyed from a toner cartridge to the developing device 7 by using a supply roller 81. The image forming apparatus 1 controls a toner supply clutch to adjust rotation of the supply roller 81 such that the toner supply unit 8 supplies the toner to compensate for only a shortage according to a toner density of the developer inside the developing device 7. The agitation members 73, 74, and 75 agitate the supplied toner with the developer inside the developing device 7. Such agitation enables the supplied toner to contact the carrier in the developer, thereby charging the toner to a negative polarity by friction.

Each of the first and second developing rollers 71a and 71b includes a magnet roller thereinside. With the magnetic force, the magnet rollers attract the carrier with the toner being absorbed. This enables surfaces of the developing rollers 71a and 71b to bear the developer. The developer is then conveyed to the developing doctor 72 with the rotation of the developing rollers 71a and 71b, and the developing doctor 72 regulates an amount of the developer to a predetermined amount. Subsequently, with the rotation of the first developing roller 71a, the developer is conveyed to a first developing area opposite the photoconductor 10. Since a voltage of approximately −550 V is supplied from a developing bias power source to the first developing roller 71a, only the negatively charged toner in the developer is transferred to an area of the electrostatic latent image on the photoconductor 10 in the first developing area. Such transfer of the toner to the electrostatic latent image forms a toner image.

Moreover, after passing the first developing area, the developer on the first developing roller 71a is conveyed to an area opposite the second developing roller 71b with the rotation of the first developing roller 71a. In this area, the developer on the first developing roller 71a is moved to the second developing roller 71b. Then, with the rotation of the second developing roller 71b, the developer on the second developing roller 71b is conveyed to a second developing area opposite the photoconductor 10. Since a voltage of approximately −550 V is also supplied from the developing bias power source to the second developing roller 71b, only the negatively charged toner in the developer is transferred to an area of the electrostatic latent image on the photoconductor 10 in the second developing area. Such transfer of the toner to the electrostatic latent image forms a toner image.

While such a toner image is formed, a sheet is fed from a sheet feed cassette for storing sheets via a sheet feed unit and conveyed toward the registration roller 5 from a direction indicated by an arrow B illustrated in FIG. 1. When the sheet reaches the registration roller 5, the conveyance of the sheet temporarily stops. When the registration roller 5 is rotated to time with the conveyance of the toner image on the photoconductor 10 toward a transfer area opposite a transfer belt 61 of the transfer device 6, the sheet is conveyed toward the transfer area.

The transfer belt 61 includes an endless belt made of a material such as rubber having a middle resistance. The transfer belt 61 is looped around a drive roller 62, a driven roller 63, and a bias roller 64. A high-voltage power source 65 used for a transfer operation applies a transfer bias to the bias roller 64 such that an electric current flowing to the photoconductor 10 is controlled to be constant. In the transfer area, the transfer bias applied to the bias roller 64 enables the toner image on the photoconductor 10 to be transferred to the sheet. With the rotation of the transfer belt 61, the sheet with the transferred toner image is conveyed to a fixing device 90 with the transfer belt 61 bearing the sheet. The fixing device 90 fixes the toner image on the sheet, and the sheet with the fixed image is discharged outside the image forming apparatus 1.

A photoconductor cleaning device 91 includes a brush roller 92 and a cleaning blade 93 to remove a residual toner from the surface of the photoconductor 10, the residual toner remaining on the photoconductor 10 without being transferred to the sheet. After the residual toner is removed, a discharge lamp 94 serving as a discharge unit discharges the surface of the photoconductor 10.

Moreover, as illustrated in FIG. 1, the image forming apparatus 1 includes a development drive time measuring circuit 85. The development drive time measuring circuit 85 detects a drive time of the developing motor 87 to measure a development drive time (a duration of time from the beginning to the end of rotation of the developing motor 87) for each job.

Moreover, the image forming apparatus 1 includes an average unit-sheet-quantity measuring circuit 83 that converts the development drive time into the number of sheets. In particular, the average unit-sheet-quantity measuring circuit 83 converts the development drive time of one job measured by the development drive time measuring circuit 85 into the number of sheets (average unit-sheet-quantity) that would be needed if images are formed on a predetermined number of sheets (unit quantity) of a prescribed size (e.g., A4 size). The average unit-sheet-quantity measuring circuit 83 transmits an average unit-sheet-quantity signal to the controller 100 each time a development drive time measured by the development drive time measuring circuit 85 reaches a prescribed time (a development drive time that would be needed if the images are formed on the predetermined number of sheets of the prescribed size).

Moreover, the image forming apparatus 1 includes a sheet size detector 84 that detects size of a sheet actually to be used for image formation. The sheet size detector 84 transmits the detected sheet size to the controller 100.

Hereinafter, a description is given of a control operation performed when the number of output sheets to be generated by the end of a lifetime of the developer is estimated (lifetime sheet quantity estimation control) as the degree of carrier deterioration.

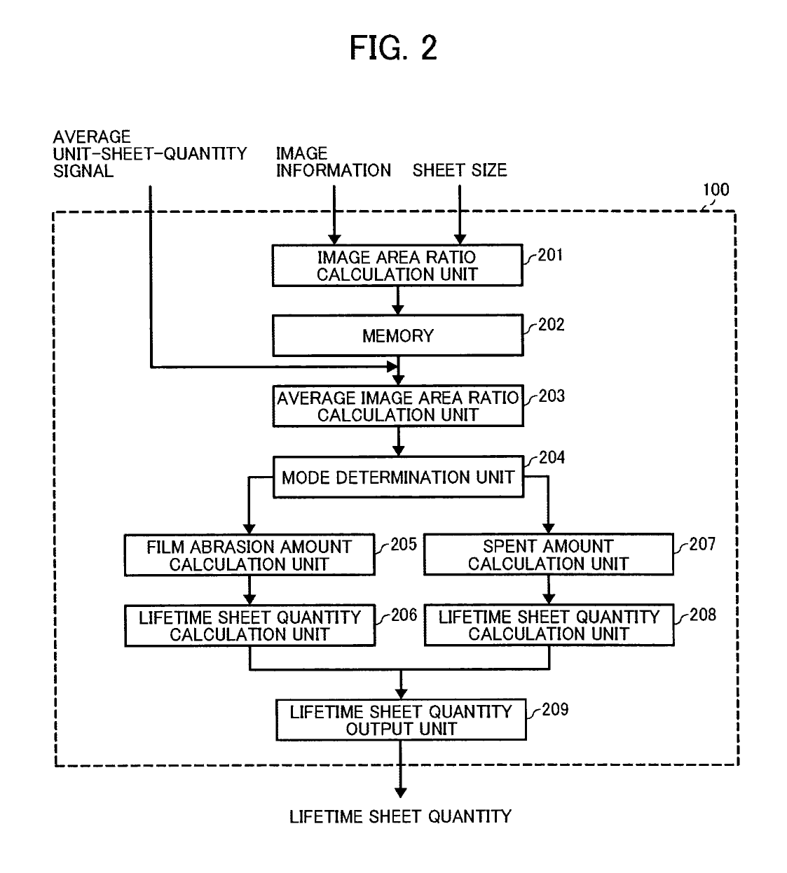

FIG. 2 is a block diagram of the controller 100 for estimating the lifetime sheet quantity. As illustrated in FIG. 2, the controller 100 serving as a device for carrier deterioration estimation includes an image area ratio calculation unit 201, a memory 202, an average image area ratio calculation unit 203, a mode determination unit 204, a film abrasion amount calculation unit 205, a lifetime sheet quantity calculation unit 206, a spent amount calculation unit 207, a lifetime sheet quantity calculation unit 208, and a lifetime sheet quantity output unit 209. The spent amount calculation unit 207 and the lifetime sheet quantity calculation unit 208 serve as a first carrier deterioration calculation unit. The film abrasion amount calculation unit 205 and the lifetime sheet quantity calculation unit 206 serve as a second carrier deterioration calculation unit. Each of the mode determination unit 204 and the lifetime sheet quantity output unit 209 serves as a carrier deterioration degree output unit.

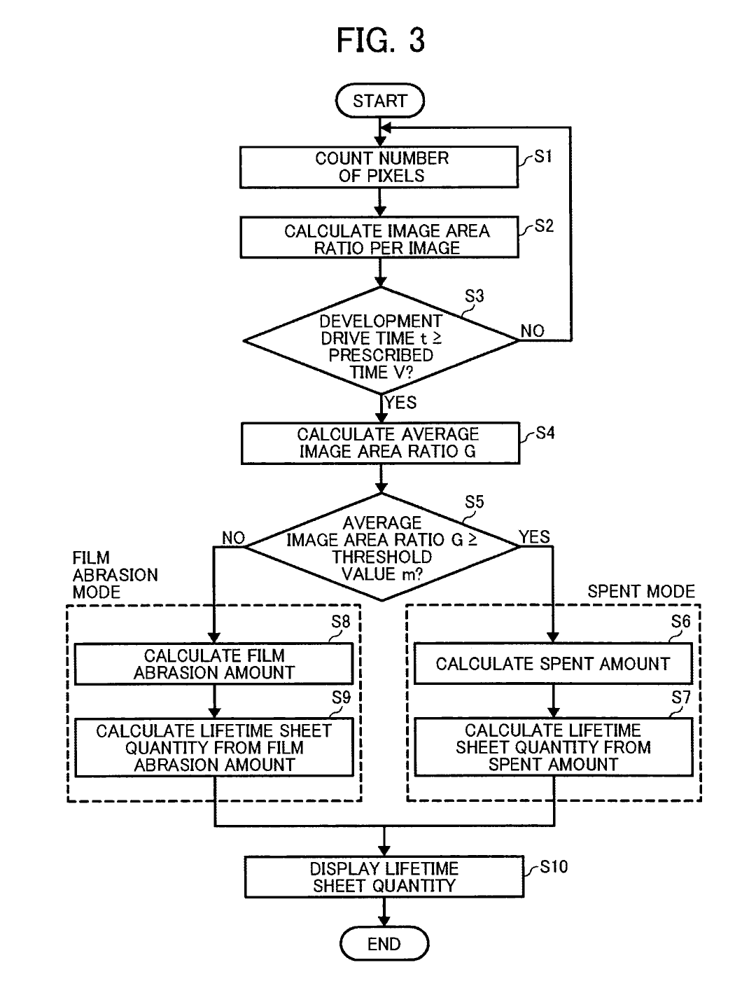

FIG. 3 is a flowchart of the control operation performed when the lifetime sheet quantity is estimated. In step S1 illustrated in FIG. 3, the image area ratio calculation unit 201 counts the number of pixels based on the image information to be stored in the image memory of the image memory control unit 111. In step S2, the image area ratio calculation unit 201 calculates an image area ratio of an image corresponding to the image information from the number of pixels counted in step S1 and from sheet size information transmitted from the sheet size detector 84. The image area ratio calculation unit 201 stores the calculated image area ratio in the memory 202.

In step S3, the development drive time measuring circuit 85 transmits an average unit-sheet-quantity signal to the controller 100 each time a development drive time “t” measured by the development drive time measuring circuit 85 reaches a prescribed time “V” (YES in step S3). In step S4, upon receipt of the average unit-sheet-quantity signal, the average image area ratio calculation unit 203 of the controller 100 reads each of the image area ratios stored in the memory 202 to calculate an average value serving as an index value (an average image area ratio G) of these image area ratios. The thus-calculated average image area ratio calculation unit 203 calculates the average image area ratio G as an average ratio value that would be obtained on the basis of a predetermined number of sheets (unit quantity) if images are formed on the predetermined number of sheets (e.g., 100 sheets) of prescribed size (e.g., A4 size).

In step S5, the mode determination unit 204 determines whether the calculated average image area ratio G equals or exceeds a threshold “m”. If the average image area ratio G is less than the threshold “m” (NO in step S5), the mode determination unit 204 issues a command to the film abrasion amount calculation unit 205 to calculate a film abrasion amount of the carrier so that a lifetime sheet quantity is calculated in a film abrasion mode. On the other hand, if the average image area ratio G is the threshold “m” or greater (YES in step S5), the mode determination unit 204 issues a command to the spent amount calculation unit 207 to calculate a spent amount so that a lifetime sheet quantity is calculate in a spent mode.

In step S5, the parameters (the film abrasion amount and the spent amount) needs to be changed depending on the average image area ratio G to calculate the lifetime sheet quantity accurately. The necessity for such a change is described below.

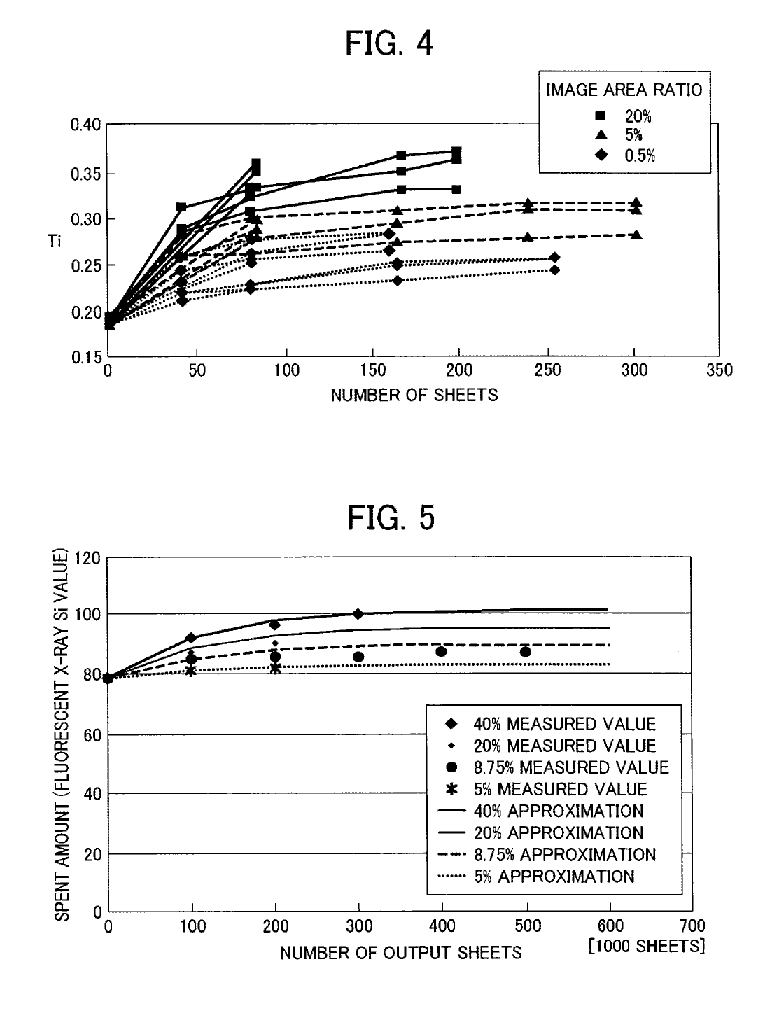

FIG. 4 is a graph of a relationship between the number of output sheets and a spent amount when an image area ratio is changed. An amount of toner or an external additive of the toner (a spent amount) adhering to a surface of the carrier can be measured by fluorescent X-ray analysis. Herein, an amount of silica serving as the additive of the toner adhering to the carrier surface is measured by fluorescent X-ray analysis, and a result of the measurement is defined as a spent amount.

As illustrated in the graph of FIG. 4, at every image area ratio (0.5%, 5%, 20%) in an initial stage, the larger the number of output sheets, the larger the spent amount (i.e., the spent amount increases as a development drive time advances). However, when the number of output sheets reaches a certain level, the spent amount reaches saturation and does not increase further.

In such a case, since the developer inside the developing device 7 continuously receives a certain amount of mechanical stress from the agitation members 73, 74, and 75, it is conceivable that the surface of the carrier could be abraded by a certain amount as the number of output sheets increases. The surface of the carrier particles has an area that is not covered with the additive and an area that is covered with the additive. Mechanical stress causes the area of the carrier surface not covered with the additive to be abraded, while at the same time causing the additive to be abraded from the area of the carrier surface covered therewith instead of abrading the carrier surface.

When the number of output sheets is increased by a certain image area ratio, an area of the carrier surface covered with the additive is small in an initial stage (i.e., the number of output sheets is small) at any image area ratio. Thus, an amount of the additive abraded from the carrier surface by mechanical stress is small. Consequently, an amount of additive newly adhering to the carrier surface exceeds the amount of the additive abraded from the carrier surface by mechanical stress. This increases the spent amount. When the area of the carrier surface covered with the additive is increased with the increase in the spent amount, an amount of the additive abraded from the carrier surface by mechanical stress increases. This decreases a difference between the amount of the additive abraded from the carrier surface by mechanical stress and the amount of additive newly adhering to the carrier surface. Thus, it is conceivable that such a difference can be eliminated and the spent amount cannot be increased due to saturation by the time the number of output sheets reaches some extent. This can be confirmed if the spent amount is not only increased faster but also saturated sooner as the image area ratio is higher.

Next, a relationship between the spent amount and the image area ratio is described. As illustrated in FIG. 4, the lower the image area ratio, the smaller the spent amount. In particular, when the image area ratio is low, an amount of toner to be supplied is small. Thus, an amount of a toner additive to be supplied to the developer inside the developing device 7 is small, and an increase in the spent amount decelerates. When the spent amount increases at a lower speed, an area of the carrier surface covered with the additive increases at a lower speed. This accelerates an increase in an amount of film abraded from the carrier surface by mechanical stress.

Accordingly, when the image forming apparatus 1 forms images each having a lower image area ratio, the spent amount increases at a lower speed, whereas the carrier abrasion amount increases at a higher speed. As a result, before the developer wears out due to carrier deterioration caused by the spent phenomenon, the developer wears out due to carrier deterioration caused by the carrier abrasion phenomenon.

On the other hand, when the image forming apparatus 1 forms images each having a higher image area ratio, the carrier abrasion amount increases at a lower speed, whereas the spent amount increases at a higher speed. Thus, before the developer wears out due to carrier deterioration caused by the carrier abrasion, the developer wears out due to carrier deterioration caused by the spent phenomenon. The image area ratio serving as a threshold “m” for determining which phenomenon becomes predominant can be determined experimentally with high accuracy.

In the exemplary embodiment, if the average image area ratio G is less than the threshold “m”, the carrier abrasion phenomenon predominantly affects the lifetime of the developer. Hence, a lifetime sheet quantity (a decree of second carrier deterioration) is calculated (in a film abrasion mode) based on the carrier film abrasion amount estimated by a method described below. On the other hand, if average image area ratio G is the threshold “m” or greater, the spent phenomenon predominantly affects the lifetime of the developer. Thus, a lifetime sheet quantity (a decree of first carrier deterioration) is calculated (in a spent mode) based on the spent amount estimated by a method described below.

Particularly, if the average image area ratio G is the threshold “m” or greater (YES in step S5), the mode determination unit 204 issues a command to the spent amount calculation unit 207 to execute the spent mode. In step S6, in the spent mode, the spent amount calculation unit 207 calculates a spent amount from the average image area ratio G and a development drive time “t”.

FIG. 5 is a graph of a relationship between the number of output sheets and a spent amount when images were formed on prescribed-size sheets at respective four image area ratios (5%, 8.75%, 20%, and 40%).

As for the graph illustrated in FIG. 5, the image forming apparatus 1 formed images on the prescribed-size sheets at the respective four image area ratios (5%, 8.75%, 20%, and 40%). When the number of output sheets reached a predetermined value, a spent amount of the carrier was measured by the fluorescent X-ray analysis. Such a measured value was illustrated as a plotted point in FIG. 5. Herein, main measurement conditions were as follows:

Linear speed of process: 350 [mm/s]

Linear speed of developing roller: 565 [mm/s]

Diameter of developing roller: 25 [mm]

Amount of supplied developer: 30 [mg/cm²]

Amount of developer stored inside developing unit: 650 [g]

As illustrated in FIG. 5, the spent amount corresponding to the number of output sheets varied depending on the image area ratio. In a case where a spent amount was calculated from the number of output sheets regardless of the image area ratio, a difference was generated between the calculated spent amount and the actual spent amount. Accordingly, the spent amount calculation unit 207 determined an approximation expression based on the measured values for each of the image area ratios to select the corresponding approximation expression according to the average image area ratio G. With the selected approximation expression, the spent amount calculation unit 207 calculated the spent amount. In the exemplary embodiment, since the spent amount calculation unit 207 used the development drive time “t” instead of the number of output sheets, the approximation expression was modified by replacing the number of output sheets with the development drive time “t”.

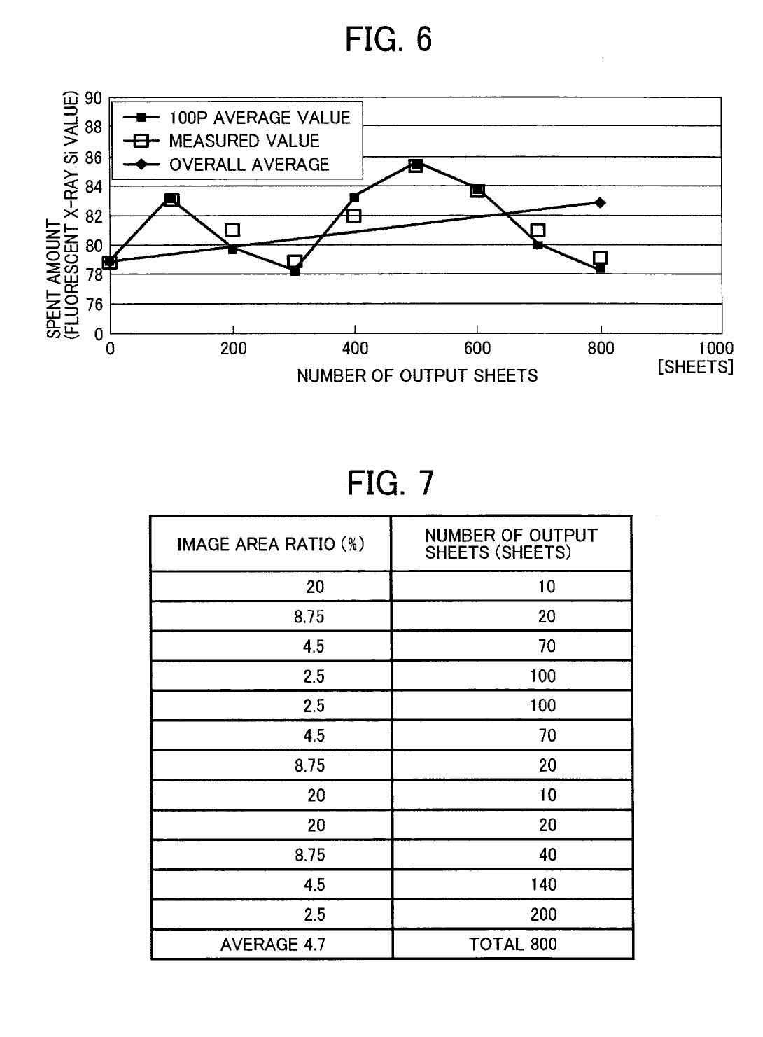

FIG. 6 is a graph of a relationship between the spent amount calculated by the spent amount calculation unit 207 and the measured value. FIG. 7 is a table illustrating changes in an image area ratio when the graph illustrated in FIG. 6 is obtained. The image forming apparatus 1 formed images on 800 sheets of prescribed size (e.g., A4) while changing the image area ratio as illustrated in FIG. 7.

In the graph of FIG. 6, a spent amount that was measured by the fluorescent X-ray analysis for every 100 sheets was illustrated as a measured value. A spent amount that was calculated by the spent amount calculation unit 207 was illustrated as a 100P average value. The 100P average value was calculated using an average image area ratio G per unit sheet of 100 sheets. Moreover, a spent amount that was acquired when images were formed on 800 sheets with an average image area ratio of 4.7% was illustrated as an overall average in FIG. 6. The average image area ratio of 4.7% was calculated as an average of fluctuations in image area ratios of all the output sheets (800 sheets). As illustrated in FIG. 6, a difference between the calculated value and the measured value was smaller than that between the overall average and the measured value. Thus, the spent amount was calculated with high accuracy.

The lifetime sheet quantity calculation unit 208 uses such a spent amount calculated with high accuracy by the spent amount calculation unit 207 to calculate a lifetime sheet quantity. Particularly, in step S7, based on comparison (e.g., a difference and a ratio) between the spent amount calculated by the spent amount calculation unit 207 and a spent lifetime threshold determined beforehand, the lifetime sheet quantity calculation unit 208 calculates the number of output sheets to be generated before the spent amount reaches the spent lifetime threshold. Herein, the number of output sheets to be generated is calculated as the lifetime sheet quantity.

On the other hand, if the average image area ratio G is less than the threshold “m” (NO in step S5), the mode determination unit 204 issues a command to the film abrasion amount calculation unit 205 to execute a film abrasion mode. In step S8, in the film abrasion mode, the film abrasion amount calculation unit 205 calculates a film abrasion amount from the average image area ratio G and the development drive time “t”. A relationship between the development drive time “t” and the film abrasion amount changes depending on the image area ratio, similar to the relationship between the development drive time “t” and the spent amount. Accordingly, similar to the spend mode, the film abrasion amount calculation unit 205 determines an approximation expression based on the measured value of the film abrasion amount corresponding to the number of output sheets at each of the image area ratios to select the corresponding approximation expression according to the average image area ratio G. With the selected approximation expression, the film abrasion amount calculation unit 205 calculates the film abrasion amount. In the exemplary embodiment, since the film abrasion amount calculation unit 205 uses the development drive time “t” instead of the number of output sheets, the approximation expression is modified by replacing the number of output sheets with the development drive time “t”.

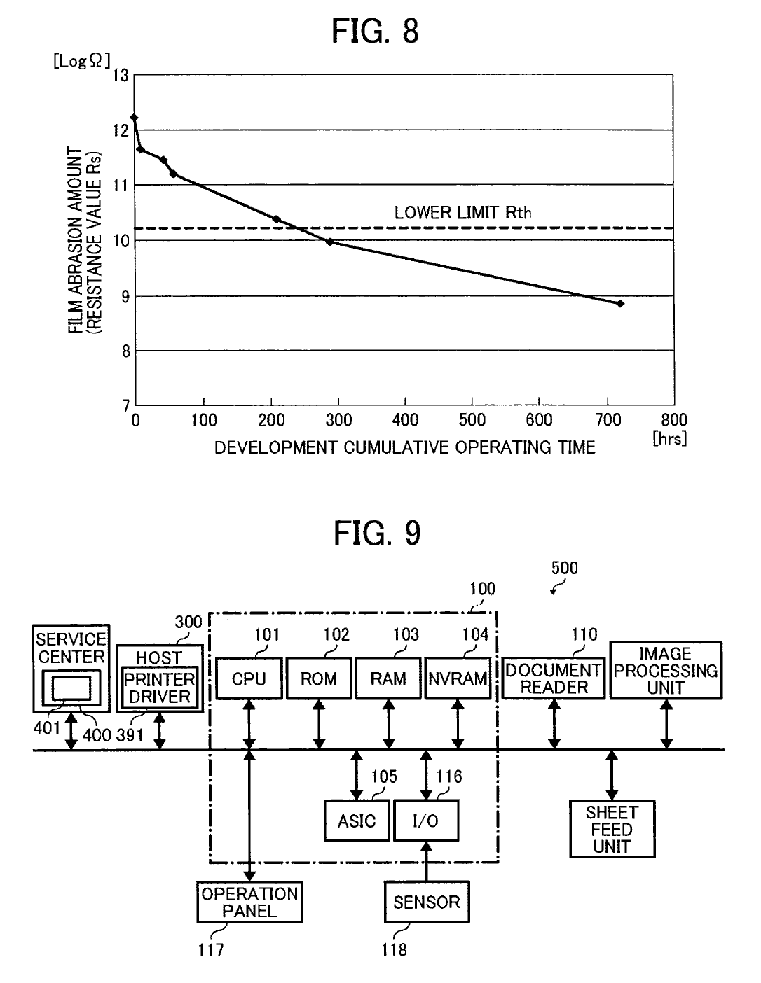

FIG. 8 is a graph of a relationship between a development cumulative operating time and a film abrasion amount. Since the film abrasion amount of the carrier was closely correlated with an electric resistance value (Rs) of the carrier, measurement of the electric resistance value (Rs) of the carrier enabled the film abrasion amount of the carrier to be estimated. In FIG. 8, the developing device 7 storing the developer in which a toner density was adjusted to 3 [wt %] was operated for 720 hours to agitate the developer, so that the carrier was forcibly degraded. As illustrated in the graph of FIG. 8, the measured electric resistance values of the carrier changed when the carrier was forcibly deteriorated. Roughly, the electric resistance values of the carrier linearly changed relative to the development cumulative operating time as illustrated in the graph of FIG. 8. In this experiment, the electric resistance values of the carrier became lower than a lower limit Rth (=11.3 Log Ω) corresponding to the lifetime of the developer (the carrier) in approximately 200 hours. This matched the actual lifetime of the developer (the carrier).

In step S9, the film abrasion amount calculated with high accuracy by the film abrasion amount calculation unit 205 is used when the lifetime sheet quantity calculation unit 206 calculates the number of lifetime sheets (the lifetime sheet quantity). In particular, based on comparison (e.g., a difference and a ratio) between the film abrasion amount calculated by the film abrasion amount calculation unit 205 and a film abrasion lifetime threshold determined beforehand, the lifetime sheet quantity calculation unit 206 calculates the number of output sheets to be generated before the film abrasion amount reaches the film abrasion lifetime threshold. Herein, the number of output sheets to be generated is calculated as the lifetime sheet quantity.

In step S10, the lifetime sheet quantity output unit 209 outputs the lifetime sheet quantity calculated in either mode to an operation panel 117 serving as a reporting unit, and the operation panel 117 displays the lifetime sheet quantity. Other information, such as the spent amount and the carrier abrasion amount, may be displayed together with the lifetime sheet quantity on the operation panel 117.

Accordingly, the lifetime sheet quantity of the developer can be estimated by the lifetime sheet quantity estimation control as long as a two-component developer containing carrier and toner is used. Note that the additive and components of the two-component developer are not limited to those described above.

In particular, the carrier may be magnetic resin carrier. For example, the magnetic resin carrier includes a core made of a material such as ferrite, magnetite, and iron powder having iron oxide as a main component, and is coated with resin serving as a coating material. The coating material for the carrier includes but is not limited to amino resin, urea-formaldehyde resin, melamine resin, benzoguanamine resin, urea resin, polyamide resin, and epoxy resin.

Moreover, the coating material may include polyvinyl, and poly vinylidene-based resin, for example, acrylic resin, polymethyl methacrylate resin, polyacrylonitrile resin, polyvinyl acetate resin, polyvinyl alcohol resin, and polyvinyl butyral resin. Moreover, the coating material may include styrene-based resin such as polystyrene resin and styrene-acrylic copolymer resin, halogenated olefin-based resin such as polyvinyl chloride, polyester-based resin such as polyethylene terephthalate resin and polybutylene terephthalate resin, polycarbonate-based resin, polyethylene resin, polyvinyl fluoride resin, polyvinylidene fluoride resin, polytrifluoroethylene resin, polyhexafluoropropylene resin, a copolymer of vinylidene fluoride and acrylic monomer, a copolymer of vinylidene fluoride and vinyl fluoride, a terpolymer of tetrafluoroethylene, vinylidene fluoride, and non-fluoride monomer, and silicone resin.

The toner can be any toner as long as it can be used for the two-component developer. Moreover, a toner including a binder resin, a colorant, a release agent, a charge-adjusting agent, or an additive may be used.

Examples of the binder resin include styrene and substituted styrene polymer such as polystyrene, poly-p-chlorostyrene, and polyvinyltoluene. Moreover, examples of the binder resin include styrene-based copolymer such as styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-α-methyl chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleate copolymer, and styrene-maleate ester copolymer. In addition, examples of the binder resin include polymethyl methacrylate, polybutyl methacrylate, polyvinyl chloride, polyvinyl acetate, polyethylene, polypropylene, polyester, epoxy resin, epoxy polyol resin, polyurethane, polyamide, polyvinyl butyral, polyacrylic resin, rosin, modified rosin, terpene resin, aliphatic or alicyclic hydrocarbon resin, aromatic petroleum resin, chlorinated paraffin, and paraffin wax. These may be used alone or in combination.

The image forming apparatus 1 can use any known dyes and pigments as a colorant. Examples of the colorant include carbon black, Nigrosine dye, black iron oxide, Naphthol Yellow S, Hansa Yellow (10G, 5G and G), cadmium yellow, yellow iron oxide, loess, chrome yellow, Titanium Yellow, Oil Yellow, Hansa Yellow (GR, A, RN and R), Pigment Yellow L, Benzidine yellow (G and GR), Permanent Yellow (NCG), Vulcan Fast Yellow (5G and R), Tartrazine Lake, Quinoline Yellow Lake, Anthrazane Yellow BGL, isoindolinone yellow, colcothar, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubin GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarin Lake, Thioindigo red B, Thioindigo Maroon, Oil Red, quinacridone red, Pyrazolone Red, Chrome Vermilion, Benzidine Orange, perinone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), indigo, ultramarine blue, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian emerald green, Pigment Green B, Naphthol green B, Green Gold, Acid Green Lake, Malachite Green Lake, Phthalocyanine Green, Anthraquinone Green, titanium oxide, zinc oxide, and lithopone. These may be used alone or in combination.

The image forming apparatus 1 can use any known inorganic fine particles and hydrophobized inorganic fine particles as an external additive. The external additive may include silica fine particles, hydrophobic silica, fatty acid metal salt (e.g., zinc stearate and aluminum stearate), metal oxide (e.g., titanium oxide, alumina, tin oxide, and antimony oxide), and fluoropolymer. Particularly, hydrophobized silica, titanium oxide, and alumina fine particles are preferably used.

Examples of the inorganic fine particles for the external additive include titanium oxide, barium titanate, magnesium titanate, calcium titanate, strontium titanate, iron oxide, copper oxide, zinc oxide, tin oxide, quartz sand, clay, mica, wollastonite, diatomaceous earth, chromium oxide, cerium oxide, colcothar, antimony trioxide, magnesium oxide, zirconium oxide, barium sulfate, barium carbonate, calcium carbonate, silicon carbide, and silicon nitride.

Particularly, the image forming apparatus 1 can preferably use silica and titanium dioxide as the external additive.

Examples of the release agent include solid paraffin wax, microcrystalline wax, rice wax, fatty acid amide-based wax, fatty acid-based wax, aliphatic monoketones, fatty acid metal salt wax, fatty acid ester wax, partially saponified fatty acid ester wax, silicone varnish, higher alcohol, and carnauba wax.

In the foregoing description, the image forming apparatus 1 uses the operation panel 117 as a reporting unit that notifies a user or a maintenance service person of a lifetime sheet quantity (the degree of carrier deterioration). However, the reporting unit is not limited thereto as long as the lifetime sheet quantity can be conveyed to the user and the maintenance service person. For example, the image forming apparatus 1 may use a unit that flashes on and off to visually notify the user and the maintenance service person of a message such as warning, instead of using the operation panel 117. Alternatively, the image forming apparatus 1 may use a unit that uses audible sounds to notify the user and the maintenance service person of a message. In a case where the image forming apparatus 1 includes a plurality of developing devices, the lifetime sheet quantity estimation control is preferably executed for each developing device. In such a case, when a lifetime sheet quantity is notified to the user or the maintenance service person, the image forming apparatus 1 may preferably display which lifetime sheet quantity belongs to which developing device.

Moreover, the image forming apparatus 1 may be connected to a service terminal (a management device) 400 via a communication network. The service terminal 400 performs maintenance and management operations on the image forming apparatus 1. In such a case, the image forming apparatus 1 may transmit information such as a lifetime sheet quantity calculated by the lifetime sheet quantity estimation control to the service terminal 400 via the communication network. This enables the maintenance service person (e.g., a maintenance administrator) to replace the developer (carrier) of the image forming apparatus 1 with new developer or supply developer to the image forming apparatus 1 at appropriate timing.

Moreover, since the image forming apparatus 1 uses the two-component developer as described above, the image forming apparatus 1 preferably includes a reporting unit that notifies the user or the maintenance service person of a time when the toner replenishment is needed. For example, when the amount of toner remaining inside a toner bottle is small, and/or when the toner inside the toner bottle runs out, the reporting unit notifies the user or the maintenance service person accordingly.

The reporting unit may have any configuration as long as the user or the maintenance service person can be notified of a time when the toner replenishment is needed. For example, the reporting unit may be the operation panel 117 of the image forming apparatus 1. Alternatively, the reporting unit may be an indicator lamp that lights or blinks. In a case where the image forming apparatus 1 includes a plurality of toner bottles, the reporting unit is preferably configured to clearly indicate what notification belongs to which toner bottle. Moreover, in a case where the image forming apparatus 1 is connected to the service terminal 400 via a network, the image forming apparatus 1 preferably include a developer information transmission unit that can transmit information about a state of developer toner to the service terminal. For example, information such as a remaining toner amount in a toner bottle can be transmitted to the service terminal. This enables the maintenance service person to supply toner to the image forming apparatus 1 at an appropriate timing. Accordingly, the user and/or the maintenance service person can stock and supply replacement toner at an appropriate timing.

The image forming apparatus 1 may include one of the reporting unit for notifying the user or the maintenance service person of the replacement timing of the carrier of the developer and the reporting unit for notifying the user or the maintenance service person of the replenishment timing of the toner. Alternatively, the image forming apparatus 1 may include both of the reporting units. That is, the image forming apparatus 1 can include the reporting unit or units for notifying the user or the maintenance service person of the replacement timing of the developer and/or the replenishment timing of the toner. Accordingly, the image forming apparatus 1 can have a function or functions of notifying the user or the maintenance service person of a time when the developer (carrier) should be replaced and/or the toner should be replenished (the toner bottle should be replaced). Particularly, the image forming apparatus 1 may preferably include a reporting unit that can notify the user or the maintenance service person of both of the developer (carrier) replacement timing and the toner replenishment timing (toner bottle replacement) so that the developer of the image forming apparatus 1 is maintained at an appropriate state.

FIG. 9 is a schematic diagram of a maintenance management system 500, serving as an image forming apparatus management system, in which an image forming apparatus 1 is connected to a service terminal 400 serving as a management device via a communication network according to an exemplary embodiment. Devices, apparatuses, components, and configurations that are similar to the above description will be given the same reference numerals as above and description thereof will be omitted. The service terminal 400 is used to perform a management operation including maintenance and checking of the image forming apparatus 1. The service terminal 400 includes a reporting unit 401 to report that the carrier deterioration is transmitted from a carrier deterioration transmission unit of the image forming apparatus 1. In the maintenance management system 500, for example, the service terminal 400 placed in a service center can monitor whether developer (carrier) is replaced and toner is supplied (toner bottle is replaced), and estimate a time when the developer should be replacement and the toner should be supplied.

In the maintenance management system 500 illustrated in FIG. 9, the controller 100 of the image forming apparatus 1 includes a central processing unit (CPU) 101, a read only memory (ROM) 102, a random access memory (RAM) 103, a non-volatile RAM (NVRAM) 104, an application specific integrated circuit (ASIC) 105, an input/output (I/O) port 106. The CPU 101 comprehensively controls access to various devices connected to a system bus based on a control program stored in the ROM 102. Moreover, the CPU 101 can control inputs to and outputs from electrical equipment such as a sensor connected to the input/output (I/O) port 116. The CPU 101 can also communicate with an external device such as a host computer 300 via an external interface (I/F) or a printer driver 391.

The random access memory (RAM) 103 functions as a main memory and a work area of the CPU 101. The RAM 103 can expand a memory capacity by using an option RAM connected to an expansion port. The RAM 103, for example, is used as an area to which recording data is loaded and environment data is stored. The NVRAM 104 is installed, for example, in each toner bottle, to store information such as a consumption amount of toner inside the toner bottle. Moreover, a setting such as a printer mode and a print condition can be set on an operation panel 117. A sensor 118 includes an average unit-sheet-quantity measuring circuit 83, a sheet size detector 84, and a sensor that detects a remaining amount of toner inside the toner bottle. The service terminal 400 is connected to the image forming apparatus 1 via an external I/F and a network. The network connecting the service terminal 400 and the image forming apparatus 1 is any of a wired network and a wireless network.

The service terminal 400 performs a management operation including maintenance and checking of the image forming apparatus 1. Particularly, the service terminal 400 automatically monitors a problem of the image forming apparatus 1. For example, in a case where a problem that cannot be handled by a user side occurs, the image forming apparatus 1 notifies the service terminal 400 accordingly. In the maintenance management system 500, the service terminal 400 can perform a maintenance and checking operation on the image forming apparatus 1 to solve the problem.

According to such a maintenance management system 500, when a predetermined condition is satisfied, the lifetime sheet quantity estimation control is executed. In the exemplary embodiment, a program for executing the lifetime sheet quantity estimation control may be preloaded in the image forming apparatus 1 such that the program can be activated at any time. Moreover, for example, such a program may be preloaded or downloaded from the service terminal 400 into the image forming apparatus 1 when necessary. The maintenance management system 500 issues an instruction for activation of the program for executing the lifetime sheet quantity estimation control, for example, when an optional condition or a prescribed condition is satisfied. The optional condition may include an instruction from the service terminal 400 and an instruction from the operation panel 117. The prescribed condition may include each printing of the predetermined number of sheets and each stop of a developing sleeve.

The image forming apparatus 1 executes the lifetime sheet quantity estimation control as described above. However, the lifetime sheet quantity estimation control may be partially or entirely executed by the service terminal 400.

In the above description, the lifetime sheet quantity is used as the degree of carrier deterioration, the lifetime sheet quantity indicating the number of output sheets to be generated on prescribed-size sheets before the lifetime of developer ends. However, the degree of carrier deterioration is not limited to the lifetime sheet quantity. Any information may be used as the degree of carrier deterioration as long as a user and/or a maintenance service person can be notified of the degree of carrier deterioration. Moreover, the development cumulative operating time is used as agitation time indicating a time period for which the two-component developer in the developing device 7 is agitated. However, other information may be used as the agitation time as long as the information is correlated with the agitation time indicating a time period for which the two-component developer in the developing device 7 is agitated. For example, the actual number of output sheets may be used as the agitation time. Moreover, the average image area ratio G acquired based on the image area ratio calculated from the image information is used as the toner consumption indicating an amount of toner consumed by the developing device 7. However, other information may be used as long as the information is correlated with the toner consumption amount.

The above description is merely one example. The device for carrier deterioration estimation, the image forming apparatus, and the maintenance management system can provide effects in aspects below.

### (Aspect A)

A device for carrier deterioration estimation estimates carrier deterioration indicating a degree of deterioration of carrier inside a developing device 7 of an image forming apparatus 1. The developing device 7 develops a latent image formed on a latent image bearer such as a photoconductor 10 to form a toner image while a two-component developer containing carrier and toner including an additive made of a material such as silica is agitated inside the developing device 7. The toner image developed by the developing device 7 is eventually transferred to a recording material. Such a device for carrier deterioration estimation includes a first carrier deterioration calculation unit such as a spent amount calculation unit 207 and a lifetime sheet quantity calculation unit 208, a second carrier deterioration calculation unit such as a film abrasion amount calculation unit 205 and a lifetime sheet quantity calculation unit 206, and a carrier deterioration degree output unit such as a mode determination unit 204 and a lifetime sheet quantity output unit 209. The first carrier deterioration calculation unit uses toner consumption and agitation time to calculate a first carrier deterioration degree indicating a degree of carrier deterioration caused by a spent phenomenon in which toner or an additive of toner adheres to a surface of the carrier. The toner consumption indicates an amount of toner consumed by the developing device 7, whereas the agitation time indicates a time period for which the two-component developer in the developing device 7 is agitated. The second carrier deterioration calculation unit uses the toner consumption and the agitation time to calculate a second carrier deterioration degree indicating a degree of carrier deterioration caused by a carrier abrasion phenomenon in which a surface of the carrier is abraded by the agitation inside the developing device 7. The carrier deterioration degree output unit uses the toner consumption to select one of the first carrier deterioration degree calculated by the first carrier deterioration calculation unit and the second carrier deterioration degree calculated by the second carrier deterioration calculation unit. The carrier deterioration degree output unit outputs the selected carrier deterioration degree as a degree of carrier deterioration. In a case where the carrier is continuously used while an area of the carrier surface covered with a substance such as an additive is small, the carrier deterioration due to abrasion of the carrier surface itself by mechanical stress caused by the agitation of the developer is faster than that due to an increase in a spent amount of the additive adhering to the carrier surface. In such a case, the carrier abrasion phenomenon predominantly affects the degree of carrier deterioration in comparison with the spent phenomenon. Thus, the degree of carrier deterioration can be calculated more accurately from the carrier abrasion amount. On the other hand, in a case where the carrier is continuously used while an area of the carrier surface covered with an additive is large, the carrier deterioration due to an increase in a spent amount of the substance such as the additive adhering to the carrier surface is faster than that due to abrasion of the carrier surface itself by mechanical stress caused by the agitation of the developer. In such a case, the spent phenomenon predominantly affects the degree of carrier deterioration in comparison with the carrier abrasion phenomenon. Thus, the degree of carrier deterioration can be calculated more accurately from the spent amount. Accordingly, the accuracy of the carrier deterioration calculated from any of the information depends on the area size of the carrier surface covered with the additive by the continuous use of the developer. This area size can be determined with high accuracy from the toner consumption indicating an amount of toner consumed by the developing device 7. The area size of the carrier surface covered with a substance such as an additive by the continuous use of the developer is highly correlated with a toner supply amount (an amount of the substance such as the additive supplied to the developing device 7) to the developing device 7, and the toner consumption is highly correlated with the toner supply amount. Thus, with the toner consumption amount, the area size can be determined with high accuracy. Therefore, the device for carrier deterioration estimation can appropriately select which carrier deterioration degree is more accurate either the first carrier deterioration degree based on the spent amount information or the second carrier deterioration degree based on the carrier abrasion information, thereby outputting the carrier deterioration degree having higher accuracy. Moreover, the device for carrier deterioration estimation uses not only the agitation time but also the toner consumption to calculate the second carrier deterioration degree based on the carrier abrasion information. As described, a difference in the toner consumption (e.g., a printing ratio (an image area ratio)) causes a lifetime of the developer affected by the carrier abrasion phenomenon to end at a different time. Thus, the use of the agitation time and the toner consumption enables the second carrier deterioration degree based on the carrier abrasion information to be calculated more accurately than the use of only the agitation time.

### (Aspect B)

In the device for carrier deterioration estimation with the aspect A, the toner consumption is information of an image area ratio of an image to be formed or information derived from the image area ratio. With such toner consumption, the device for carrier detection estimation can select a high-accurate carrier deterioration degree more easily, and output the selected carrier deterioration degree.

### (Aspect C)

In the device for carrier deterioration estimation with the aspect A or B, the carrier deterioration degree output unit selects the first carrier deterioration degree where an index value such as an average image area ratio G is a prescribed value such as a threshold “m” or greater. The index value indicates, for example, a toner consumption amount per unit agitation time determined by the toner consumption and the agitation time. On the other hand, the carrier deterioration degree output unit selects the second carrier deterioration degree where the index value is less than the prescribed value. With such a carrier deterioration degree output unit, the device for carrier deterioration estimation can select a carrier deterioration degree calculated more accurately, and output the selected carrier deterioration degree.

### (Aspect D)

An image forming apparatus includes a latent image bearer such as a photoconductor 10, a developing device 7, the device for carrier deterioration estimation with any of the aspects A through C, and a reporting unit such as an operation panel 117. In the image forming apparatus, a toner image developed by the developing device 7 is eventually transferred to a recording medium such as a sheet to form an image on the recording medium. The developing device 7 develops a latent image on the latent image bearer with toner in a two-component developer containing carrier and the toner including an additive. The reporting unit notifies a carrier deterioration degree such as a lifetime sheet quantity output from the device for carrier deterioration estimation to a user, for example. With such configuration, the image forming apparatus can notify the user or the maintenance service person of a carrier deterioration degree having higher accuracy, so that developer can be replaced at more appropriate timing.

### (Aspect E)

An image forming apparatus includes a latent image bearer such as a photoconductor 10, a developing device 7, the device for carrier deterioration estimation with any of the aspects A through C, and a carrier deterioration degree transmission unit such as a communication device. In the image forming apparatus, a toner image developed by the developing device 7 is eventually transferred to a recording medium such as a sheet to form an image on the recording medium. The developing device 7 develops a latent image on the latent image bearer with toner in a two-component developer containing carrier and toner including an additive. The carrier deterioration degree transmission unit transmits a carrier deterioration degree output from the device for carrier deterioration estimation to an external device such as a service terminal 400. With such configuration, the image forming apparatus can notify the external device of a carrier deterioration degree having higher accuracy, so that developer can be replaced at more appropriate timing.

### (Aspect F)

An image forming apparatus management system includes an image forming apparatus, and a management device such as a service terminal connected to the image forming apparatus via a communication network. The image forming apparatus management system uses the image forming apparatus having the aspect E as the image forming apparatus. The management device include a reporting unit, such as a monitor, that notifies an operator such as a maintenance service person of a carrier deterioration degree transmitted from a carrier deterioration degree transmission unit of the image forming apparatus. With such configuration, the image forming apparatus management system can notify the operator of a carrier deterioration degree having higher accuracy, so that developer of the image forming apparatus can be replaced at a more appropriate timing.

The present invention has been described above with reference to specific exemplary embodiments. Note that the present invention is not limited to the details of the embodiments described above, but various modifications and enhancements are possible without departing from the spirit and scope of the invention. It is therefore to be understood that the present invention may be practiced otherwise than as specifically described herein. For example, elements and/or features of different illustrative exemplary embodiments may be combined with each other and/or substituted for each other within the scope of the present invention.

What is claimed is:

1. A device for an image forming apparatus that estimates carrier deterioration indicating a degree of deterioration of carrier using a two-component developer containing carrier and toner including an additive, the device comprising;
a first carrier deterioration calculation unit to use toner consumption indicating an amount of toner consumed by a developing device and agitation time indicating a time period for which the two-component developer in the developing device is agitated to calculate a first carrier deterioration degree indicating a degree of carrier deterioration caused by a spent phenomenon, in which toner or an additive of toner adheres to a carrier surface;
a second carrier deterioration calculation unit to use the toner consumption and the agitation time to calculate a second carrier deterioration degree indicating a degree of carrier deterioration caused by a carrier abrasion phenomenon, in which a carrier surface is abraded by agitation inside the developing device; and
a carrier deterioration degree output unit to use the toner consumption to select one of the first carrier deterioration degree and the second carrier deterioration degree, and to output the selected carrier deterioration degree.

2. The device according to claim 1, wherein the carrier deterioration degree output unit selects the first carrier deterioration degree where an index value indicating a toner consumption amount per unit agitation time determined by using the toner consumption and the agitation time is a threshold or greater, and selects the second carrier deterioration degree where the index value is less than the threshold.

3. An image forming apparatus comprising:
a latent image bearer;
a developing device to develop a latent image on the latent image bearer with a two-component developer containing carrier and toner including an additive; and
a device to estimate carrier deterioration indicating a degree of deterioration of carrier inside the developing device,
the device for carrier deterioration estimation including:
a first carrier deterioration calculation unit to use toner consumption indicating an amount of toner consumed by the developing device and agitation time indicating a time period for which the two-component developer in the developing device is agitated to calculate a first carrier deterioration degree indicating a degree of carrier deterioration caused by a spent phenomenon, in which toner or an additive of toner adheres to a carrier surface;
a second carrier deterioration calculation unit to use the toner consumption and the agitation time to calculate a second carrier deterioration degree indicating a degree of carrier deterioration caused by a carrier abrasion phenomenon, in which a carrier surface is abraded by agitation inside the developing device; and
a carrier deterioration degree output unit to use the toner consumption to select one of the first carrier deterioration degree and the second carrier deterioration degree, and to output the selected carrier deterioration degree.

4. The image forming apparatus according to claim 3, wherein the toner consumption is information of an image area ratio of an image formed by using the developing device or information derived from the image area ratio.

5. The image forming apparatus according to claim 3, wherein the carrier deterioration degree output unit selects the first carrier deterioration degree where an index value indicating a toner consumption amount per unit agitation time determined by using the toner consumption and the agitation time is a threshold or greater, and selects the second carrier deterioration degree where the index value is less than the threshold.

6. The image forming apparatus according to claim 3, further comprising a reporting unit to report the carrier deterioration degree output from the device for carrier deterioration estimation.

7. The image forming apparatus according to claim 3, further comprising a carrier deterioration degree transmission unit to transmit the carrier deterioration degree output from the device for carrier deterioration estimation to an external device via a communication network.

8. An image forming apparatus management system comprising:
an image forming apparatus; and
a management device connected to the image forming apparatus via a communication network,
the image forming apparatus including:
a latent image bearer;
a developing device to develop a latent image on the latent image bearer with a two-component developer containing carrier and toner including an additive;
a device to estimate carrier deterioration indicating a degree of deterioration of carrier inside the developing device; and
a carrier deterioration degree transmission unit to transmit a carrier deterioration degree output from the device for carrier deterioration estimation to an external device via a communication network,
the device for carrier deterioration estimation including:
a first carrier deterioration calculation unit to use toner consumption indicating an amount of toner consumed by the developing device and agitation time indicating a time period for which the two-component developer in the developing device is agitated to calculate a first carrier deterioration degree indicating a degree of carrier deterioration caused by a spent phenomenon, in which toner or an additive of toner adheres to a carrier surface;
a second carrier deterioration calculation unit to use the toner consumption and the agitation time to calculate a second carrier deterioration degree indicating a degree of carrier deterioration caused by a carrier abrasion phenomenon, in which a carrier surface is abraded by agitation inside the developing device; and
a carrier deterioration degree output unit to use the toner consumption to select one of the first carrier deterioration degree and the second carrier deterioration degree, and to output the selected carrier deterioration degree, and
the management device including a reporting unit to report that the carrier deterioration degree is transmitted from the carrier deterioration degree transmission unit of the image forming apparatus.

9. The image forming apparatus management system according to claim 8, wherein the toner consumption is information of an image area ratio of an image formed by using the developing device or information derived from the image area ratio.

10. The image forming apparatus management system according to claim 8, wherein the carrier deterioration degree output unit selects the first carrier deterioration degree where an index value indicating a toner consumption amount per unit agitation time determined by using the toner consumption and the agitation time is a threshold or greater, and selects the second carrier deterioration degree where the index value is less the threshold.

11. The image forming apparatus management system according to claim 8, wherein the image forming apparatus further includes a reporting unit to report the carrier deterioration degree output from the device for carrier deterioration estimation.
